(19) United States
(12) Patent Application Publication
(10) Pub. No.: US 2006/0246402 A1
(43) Pub. Date: Nov. 2, 2006

(54) Processing of shape data of a dental prosthesis

(76) Inventors: Michael A. Kraemer, Landsberg am Lech (DE); Bernd K. Burger, Alling (DE); Holger Hauptmann, Sindelsdorf (DE); Guenter Hertlein, Seefeld (DE); Stefan Hoeschefer, Herrsching (DE); Markus P. Salex, Martinsried (DE)

Correspondence Address: 3M INNOVATIVE PROPERTIES COMPANY, PO BOX 33427, ST. PAUL, MN, 55133-3427, US

(21) Appl. No.: 10/550,992

(22) PCT Filed: Mar. 25, 2004
(86) PCT No.: PCT/EP04/03169

§ 371 Date: Sep. 26, 2005

(30) Foreign Application Priority Data
Mar. 26, 2003 (DE) 103 13 690.8

(51) Int. Cl. A61C 5/10

(52) U.S. Cl. 433/223

(57) ABSTRACT

The invention relates to the processing of data regarding the three dimensional shape of a dental prosthesis, which has two prosthesis sections and a connector section, said connector section being connected to the two prosthesis sections and less stable than the two prosthesis sections, comprising the steps that:—a stability parameter and a stability criterion are determined for the connector section;—for the stability parameter, the actual value is calculated from the data;—it is checked for the connector section as to whether the actual value fulfills the stability criterion, and if not, that a warning signal is generated, wherein the determination of the stability criterion is dependent on at least one of the following prosthesis attributes:—the configuration of the prosthesis;—the position of the prosthesis inside the mouth;—the material and/or the cross-sectional profile of the connector section;—the type of the prosthesis sections adjoining the connector section.

### BACKGROUND OF THE INVENTION

1. Technical Field

The present invention relates to the production of dental replacement, more precisely to the processing of data about the three-dimensional shape of a dental prosthesis, which has two prosthesis sections and a connector section, said connector section being connected to the two prosthesis sections and less stable than the two prosthesis sections.

The term “dental prosthesis” is to be understood here in the broadest sense and is intended to include all types of dental replacement like, for example, bridges, implants, and dental prostheses in the narrower sense, but also parts of such dental prostheses like, for example, bridge sub-structures or copings onto which a veneering must still be applied in order to obtain the finished bridge.

The quantity indications used here like, for example, “two prosthesis sections” or “a connector section”, are in general to be understood as a minimum with the meaning of “at least two” or “at least one”, in case a limitation is not expressed by wording like “exactly” or “consists of”.

The present invention thus includes, for example, not only two-unit bridge copings where the two units are connected by one connector, but also three- and multi-unit bridge copings, where each two neighboring units are connected by one connector. The units may be, as needed, anchors, intermediate units also called pontics, or cantilever units: an anchor is fastened like a crown, on a tooth stump serving as a bridge abutment, an intermediate unit or pontic is fastened between two units and not to a bridge abutment, and a cantilever unit is fastened only to one unit and not to a bridge abutment.

With a one-piece bridge, thus a bridge which consists of one single piece and has no coping, neighboring bridge units border directly against one another, thus without a connector lying in between. In this case, the transition area from one unit to the other represents the connector section of the resent invention, said transition area having a more or less prominent restriction or flattening due to the shape of the units which is supposed to come as close as possible to the natural appearance of the missing teeth.

2. Description of the Related Art

It is known that the processing of data about the three-dimensional shape of a bridge coping may be done by means of a CAD (=computer-aided design) system which is part of a CIM (=computer-integrated manufacturing) system which is made available by 3M ESPE AG (Seefeld, Germany) under the name LAVA, for the production of ceramic bridge copings. With this known LAVA system, the CAD system is on the one hand connected to an optical scanner and on the other hand to a NC-milling machine. The scanner captures the three-dimensional surface of a dentition impression and passes on the captured data to the CAD system. With the CAD system, the user can modify these surface data as desired, so as to draw up the three-dimensional shape of the bridge coping, and then send the corresponding shape data to the NC-milling machine. Finally, the NC-milling machine processes a zirconium oxide or zirconia ceramic blank in an as precise as possible agreement with the shape data.

Since a dental technician must first still provide the finished, milled bridge coping with a veneer in order to give the bridge the desired natural appearance, he wishes for a connector as thin as possible because it is in his way during the application of the veneer in the contact region between two neighboring bridge units. This is especially important for the anterior teeth, as these are considerably thinner than the posterior teeth and there is thus less space available for the veneer.

But with the known method of production, the user must very carefully see to not design the connector too thin, so that they are sufficiently stable for withstanding the in part strong loadings during the milling, but also later when chewing. For this he needs a lot of experience. Since the ceramic used for the blanks is a young dental material, which is currently expensive if compared to the metal alloys used for a long time, many dental technicians are lacking the necessary experience and a costly training is needed.

### SUMMARY OF THE INVENTION

In a first aspect, the present invention relates to a process for the processing of data regarding the three-dimensional shape of a dental prosthesis, which has two prosthesis sections and a connector section, said connector section being connected to the two prosthesis sections and less stable than the two prosthesis sections, said process comprising the steps that:
a stability parameter and a stability criterion are determined for the connector section;
for the stability parameter, the actual value is calculated from the data;
it is checked for the connector section as to whether the actual value fulfills the stability criterion, and if not, that a warning signal is generated,
   wherein the determination of the stability criterion is dependent on at least one of the following prosthesis attributes:
the configuration of the prosthesis; and/or
the position of the prosthesis inside the mouth; and/or
the material and/or the cross-sectional profile of the connector section; and/or
the type of the prosthesis sections adjoining the connector section.

The present invention is described in the following using an example of a bridge coping of zirconia ceramic, without the intention of being restricted to this one particular prosthesis.

The determination of the stability parameters and stability criteria may be done by the user himself, for example, in that he defines for example that with a three-unit bridge coping for the posterior teeth, of which the configuration provides for two anchors and one pontic and which has two connectors in the form of circular cylinders, the two connectors should have a circular cross-sectional area of at least 9 mm² in order to achieve the desired stability. Thus, the stability parameter is the “circular cross-sectional area” and the stability criterion is the condition “circular cross-sectional area of at least 9 mm²”. But the determination of stability parameters and stability criteria may also be made it easier for the user in that he chooses the desired bridge coping from a product catalog and then automatically receives a proposal for stability parameters and stability criteria.

This three-unit bridge coping is an example for the above mentioned dental prosthesis, its anchors and pontic are examples for the above mentioned prosthesis sections, and its connectors are examples for the above mentioned connector section.

The configuration of the prosthesis describes, for example, whether one deals with a two or three-unit, single or two-span bridge coping with or without cantilever unit. With a four-unit, single-span bridge without cantilever unit, two pontics are connected to one another and to the two anchors lying on the outer ends, by way of three connectors, so that the central connector lying between the two pontics is exposed to the largest loading. It is thus most often sufficient to monitor its stability.

The profile of the cross-section of a connector may also deviate from the circular shape, and with a bridge coping for anterior teeth, for example, it may be stretched upwards and/or downwards, that means flattened in the front and/or back. Against loadings from above and below, such a profile offers a better resistance than a circular profile of equal size.

The computation of the actual values of the cross-sectional areas from the shape data of the current bridge coping may be done, for example, automatically by means of a computer which displays the result on a screen.

The subsequent verification as to whether these actual values are each larger or equal to 9 mm², may also be done, for example, automatically by means of the computer, which displays the result on the screen. As the warning signal, a symbol may be shown on the screen, which is, for example, a red rectangle on a menu bar. Also possible is for the connector with a cross-section smaller than 9 mm² to be displayed on the screen in a different color.

Further characteristics and embodiments of the invention are described in the subclaims.

It may be provided that the stability criterion includes a limit with which the actual value is compared. The limit may be an upper limit or a lower limit, but a limiting range defined by two limits may also be provided.

It may be provided that the minimal cross-sectional area of the connector section is one stability parameter and the stability criterion comprises a lower limit for it. With a connector in the form of a cylinder, the cross-sectional area is naturally constant over its length, however, with a connector with varying cross-sectional areas of the same profile, that specific location is the least stable where the cross-sectional area is minimal.

It may be provided that the length of the connector section is one stability parameter and the stability criterion comprises an upper limit for it.

Due to the irregular shape of the units, the length of the connector is dependent on its location and orientation with respect to the units. Further, the stability of the connector decreases with increasing length.

It may be provided that the minimal sectional modulus of the connector section is one stability parameter and the stability criterion comprises a lower limit for it. The explanations previously made with respect to the cross-sectional area can analogously be applied to the sectional modulus.

It may be provided that the stability parameter is determined by means of the finite elements method and/or the boundary element method. These methods are best carried out by means of a computer and achieve a very exact determination of the stability even for complex structures.

It may be provided that the calculation of the actual value is started conforming to a given specification. This specification may, for example, be specified by the user in that he enters into the computer a control command for starting the calculation.

It may be provided that the calculation of the actual value is started according to a given time plan. The time plan may, for example, provide for a specific cycle or pulse according to which the calculation is started.

It may be provided that the shape data can be changed or modified and that the calculation of the actual value is started as soon as the data have or were changed or modified. The change or modification of the data can be made, e.g., by the user by means of a CAD system, but it is also possible that the CAD system automatically verifies the stability, using the current shape data, and in the case of a negative verification result modifies the data so that the stability is increased.

It may be provided that the warning signal triggers a warning for the user and/or the step that the change or modification of the shape data which has lead to the non-fulfillment of the stability criterion, is reversed.

It may be provided that the process is performed by means of a computer program. This program runs, for example, in a CAD system.

In a second aspect, the present invention relates to a data processing device for performing the process according to the present invention, with:
an input device for the data;
a central unit connected to the input device, in which a program runs for the processing of the data according to the process;
an output device for the warning signal, connected to the central unit.

This device thus represents a CAD system. The input device may, for example, be connected to the output of a scanner for the three-dimensional scanning of the surface of a dentition impression. The output device may, for example, be connected to the input of an NC-milling machine or other machine for the computer-supported processing of blanks.

It may be provided that an input device for changing or modifying the data and an output device for displaying the data are connected to the central unit. This input device may, for example, be a keyboard or a mouse. The output device may, for example, be a screen.

In a third aspect, the present invention relates to a computer program which is adapted to perform the process according to the present invention.

In a fourth aspect, the present invention relates to a computer program which, when it is run in a computer, performs the process according to the present invention.

In a fifth aspect, the present invention relates to a computer program comprising commands that perform the process according to the present invention.

In a sixth aspect, the present invention relates to a computer program which implements the process according to the present invention.

In a seventh aspect, the present invention relates to a data carrier on which a computer program according to the present invention is stored. The data carrier may be, e.g., a floppy disc, a magnetic tape, a CD, a DVD, a memory stick, a hard disc, a RAM, or a ROM.

The present invention has now been described with reference to several embodiments thereof. It will be apparent to those skilled in the art that many changes can be made in the embodiments described without departing from the scope of the present invention. Thus the scope of the present invention should not be limited to the structures described in this application, but only by structures described by the language of the claims and the equivalents of those structures.

1. A method for the processing of data regarding the three-dimensional shape of a dental prosthesis, which has at least two prosthesis sections and at least one connector section, said connector section being connected to at least two prosthesis sections and less stable than the two prosthesis sections, said process comprising the steps of:
(a) determining a stability parameter and a stability criterion for the connector section;
(b) calculating a value for the stability parameter from the data; and
(c) checking the connector section to determine whether the calculated value fulfills the stability criterion, and if not, generating a warning signal;
wherein the determination of the stability criterion is dependent on at least one prosthesis attribute selected from the group consisting of: the configuration of the prosthesis; the position of the prosthesis inside the mouth; the material or the cross-sectional profile of the connector section; and the type of the prosthesis sections adjoining the connector section.

2. The method according to claim 1, wherein the stability criterion includes a limit to which the calculated value is compared.

3. The method according to claim 1, wherein the minimal cross-sectional area of the connector section is one stability parameter and the stability criterion comprises a lower limit for it.

4. The method according to claim 1, wherein the length of the connector section is one stability parameter and the stability criterion comprises an upper limit for it.

5. The method according to claim 1, wherein the minimal section modulus of the connector section is one stability parameter and the stability criterion comprises a lower limit for it.

6. The method according to claim 1, in which the stability parameter is determined by means of the finite elements method or the boundary element method.

7. The method according to claim 1, wherein the calculation of the calculated value is started conforming to a given specification.

8. The method according to claim 1, wherein the calculation of the calculated value is started according to a given time plan.

9. The method according to claim 1, wherein the shape data is modified and the calculation of the calculated value is started when the data are modified.

10. (canceled)

11. The method according to claim 1, wherein said method is performed by means of a computer program.

12. A data processing device for performing the method according to claim 1, said data processing device comprising:
(a) An input device for the data;
(b) a central unit connected to the input device, wherein said central unit runs a program for the processing of the data according to the method of claim 1; and
(c) an output device for the warning signal connected to the central unit.

13. The data processing device according to claim 12, wherein an input device for changing the data and an output device for displaying the data are connected to the central unit.

14. A computer program is adapted to perform the process according to claim 1.

15. A computer program which, when it is run in a computer, performs the process according to claim 1.

16. A computer program comprising commands that perform the process according to claim 1.

17. A computer program which implements the process according to claim 1.

18. A data carrier on which a computer program according to any of claims 14-17 is stored.
